(19) United States
(12) Patent Application Publication
(10) Pub. No.: US 2022/0395960 A1
(43) Pub. Date: Dec. 15, 2022

(54) Method of Operating a Blasting System

(71) Applicant: Rösler Holding GmbH, Bad Staffelstein (DE)

(72) Inventors: Jan Reinmann, Straufhain (DE); Marco Liske, Coburg (DE); Tom Kollacks, Bischberg (DE); Marc Eckstein, Kups (DE)

(21) Appl. No.: 17/826,117

(22) Filed: May 26, 2022

(30) Foreign Application Priority Data
Jun. 10, 2021 (DE) 102021115034.5

(51) Int. Cl. B24C 7/00

(52) U.S. Cl. CPC B24C 7/00; B24C 5/06

(57) ABSTRACT

In a method of operating a blasting system, method parameters are predefined by an operator and a required blasting medium throughput is calculated and set from these process parameters.

The present invention relates to a method of operating a blasting system that has a control and at least one turbine which is driven by an electric motor and by which granular blasting medium is accelerated and is ejected onto workpieces in a blasting chamber. Such blasting systems are generally known and usually comprise different components such as a blasting medium acceleration, a blasting medium return, a blasting medium preparation, a parts transport, and a dust removal.

For a proper operation of such a blasting system, it is, on the one hand, desirable that malfunctions are recognized in good time. On the other hand, the blasting system should be cost-effective and should be able to be operated efficiently.

It is therefore the object of the present invention to provide a method of operating a blasting system of the initially mentioned kind by which an efficient operation can be reliably achieved.

This object is satisfied by the features of claim 1 and in particular in that, in the method, a desired ejection speed and a desired blasting power of the turbine are entered as desired values in the control, in that a required blasting medium throughput is calculated from these predefined desired values, and in that a quantity of blasting medium that is fed to the turbine is set on the basis of this calculated blasting medium throughput. In accordance with the invention, the blasting medium throughput, i.e. the quantity of blasting medium that is fed to the turbine, is thus not measured, but is calculated on the basis of the predefined desired values in order, for example, to be able to compare the blasting medium throughput with the power that is actually output to the electric motor and that can, for example, be output from a frequency converter connected upstream of the electric motor. Thus, the blasting medium throughput does not have to be measured by complex and susceptible sensors and the operation of the blasting system can be represented very efficiently since the control can react very quickly to changed desired values.

Advantageous embodiments of the invention are described in the description, in the drawing, and in the dependent claims.

In accordance with a first advantageous embodiment, the ejection speed and the blasting power can be entered in the control as a percentage value. For this purpose, a maximum possible ejection speed and a maximum possible blasting power are predefined in the control, for example. This has the advantage that the operator of the system does not have to remember and enter specific numerical values that also differ from system to system or from turbine to turbine. Rather, the operator can, for example, enter the desired ejection speed between 50% and 100% and a desired power between 0% and 100% (for example, 60% speed and 90% power), which increases ease of use.

In accordance with a further advantageous embodiment, a characteristic curve that reproduces the dependence of the ejection speed of the turbine on a rotational speed of the electric motor can be stored in the control. The control can hereby calculate the ejection speed from the percentage predefined by the operator in relation to the nominal rotational speed of the motor (at operating voltage) and, with the aid of the characteristic curve, can determine the frequency which is required to achieve the desired ejection speed and with which the electric motor has to be operated. The determined frequency can then be output to a frequency converter that regulates the rotational speed of the electric motor.

In accordance with a further advantageous embodiment, the setting of the quantity of blasting medium can take place by an adjustment element controlled by the control, for example by a slider or also a slide valve that is generally known from the prior art. In accordance with the invention, the slider is, however, used not only to enable or completely interrupt the feed of blasting medium to the turbine. Rather, the slider is controlled by the control such that the opening degree is varied or adapted to allow the calculated quantity of blasting medium to pass through the slider to the turbine.

In accordance with a further advantageous embodiment, a characteristic curve that reproduces the dependence of the blasting medium throughput on an opening degree of the adjustment element can be stored in the control for this purpose. With the aid of such a characteristic curve, the opening degree of the adjustment element by which the calculated blasting medium throughput is achieved can then be predefined by the control, whereby a very fast and precise setting of the blasting medium throughput is possible.

In accordance with a further advantageous embodiment, the characteristic curve can be generated in that the adjustment element is brought into different opening positions, and in that, for each position, the current blasting medium throughput is calculated and stored from the current blasting power and the current ejection speed. If the blasting medium throughput required by the operator is calculated in the control, the control can read out the required opening degree for the adjustment element from this characteristic curve and can output it to the adjustment element. The advantage of such a characteristic curve regulation is, among other things, that it is independent of the rotational speed. Furthermore, a plurality of such characteristic curves can be stored at time intervals in the control, wherein a malfunction or wear can be indicated on a significant change of the characteristic curves in the control. If the required opening degree, for example, becomes greater over time to generate the same power consumption of the electric motor, it could be a case of wear of the turbine. In this respect, tolerance fields within which the characteristic curves can change over specific time periods can also be indicated in the control. Only when the tolerance fields are left, i.e. when there is an appreciable or significant change of the characteristic curves over time, can a malfunction message or wear message be output.

In accordance with a further advantageous embodiment, the adjustment element can be moved into a predefined end position at the start of operation such that the adjustment element adopts a defined start position at the start of operation and this position can then be defined as the zero point from which the predefined opening paths are approached to ensure a reproducibility of the system.

In accordance with a further advantageous embodiment, the electric motor can be controlled by a frequency converter, wherein the rotational speed, a current consumption, an electrical power, and/or a torque of the electric motor is/are transmitted from said frequency converter to the control. Due to these operating parameters, the control can take over a plurality of control and regulation tasks and can in particular also perform an evaluation of the efficiency of the system. With the aid of the actual rotational speed, the current ejection speed of the blasting medium can be calculated with the aid of the aforementioned characteristic curve. With the aid of the active power and the current ejection speed, the current blasting medium throughput can also be calculated and output.

In accordance with a further advantageous embodiment, the control can calculate the actual blasting power of the turbine from the electrical power of the electric motor and from a previously determined turbine efficiency that is stored in the control. This turbine efficiency depends on the design of the turbine, but can be assumed to be constant, for example having a value of 0.75, for a simplified calculation. With the aid of the actual blasting power of the turbine determined from the electrical power, the blasting work performed can be calculated taking into account the actual blasting time, i.e. that time during which the turbine runs under load, so that a plurality of evaluations can be made on the basis of the blasting work performed, which will be described in more detail in the following.

In accordance with a further advantageous embodiment, a limit value for a maximum permissible blasting medium throughput can be entered in the control so that it is prevented that a return device for blasting material is not overloaded and that the maximum blasting medium quantity of the turbine is not exceeded. Furthermore, the control can output an error message if a maximum permissible motor power is exceeded.

In accordance with a further advantageous embodiment, a storage container for blasting medium can be provided, wherein a spatial distribution of the blasting medium to be conveyed into the storage container is detected. Such a spatial detection of the blasting medium before entering into the storage container can be used not only for the detection of a maximum blasting medium throughput. Rather, the percentage share of the blasting medium throughput can hereby also be determined. An evaluation of the plausibility of the currently actually applied blasting medium quantity in relation to the detection of the spatial distribution then allows conclusions to be drawn with respect to the current state of the blasting system and the uniformity of the process. A process monitoring can therefore take place in the control in that a correlation between the detected spatial distribution of the blasting medium to be conveyed into the storage container and the calculated blasting medium throughput is established.

In accordance with a further advantageous embodiment, air can be sucked out both from the blasting chamber and from a region of a blasting medium cleaning unit, wherein a volume flow of both suctions is detected and monitored. The detection of the volume flows can take place by differential pressure measurement systems, pilot tubes, vane anemometers, or calorimetric measurement sensors. The monitoring, recording, and evaluation of the volume flows can then provide direct information on the produced parts quality with respect to the surface cleanliness of the components after the blasting process and with respect to the consistency of the blasting medium cleaning. For this purpose, it can also be advantageous if the drive motor of the air suction is equipped with a frequency converter via which a constancy of the volume flows is ensured with the aid of a rotational speed and power regulation.

In accordance with a further aspect of the present invention, in a blasting system comprising a turbine driven by an electric motor, the blasting power of the turbine and a product of the blasting power and a blasting time are determined and are displayed by the control as blasting work. The blasting power of the turbine in this respect results from the product of the electrical power and the turbine efficiency. Due to the determination of the blasting work, the combined blasting work of the total blasting system can be determined that can naturally comprise not only one, but a plurality of turbines. This cumulative blasting work performed can then be used as a basis for the evaluation of systems costs, of the machine output, and of the media consumptions. For example, the detailed blasting medium consumption (total and per turbine) or the processed parts quantity per kilowatt hour of blasting work performed can be presented. The blasting medium consumption itself can be detected in a manner known per se, for example, via a gravimetric, volume flow-based or weight-based metering system that, if required, replenishes the blasting medium quantity requested by the blasting system.

In accordance with a further aspect of the present invention, it relates to a system that is in particular suitable and configured for carrying out a method of the above kind, wherein the blasting system has a control and at least one turbine which is driven by an electric motor and by which blasting medium is accelerated and is ejected in a blasting chamber. The control of this blasting system is configured and adapted to calculate a required blasting medium throughput from a predefined ejection speed and a predefined blasting power, and to predefine the quantity of blasting medium that is fed to the turbine on the basis of the calculated blasting medium throughput.

In this respect, in accordance with an advantageous embodiment, the control can determine the performed blasting work of the blasting system and/or of individual turbines of the blasting system in real time and can output, display, store, and/or evaluate various operating parameters of the blasting system in relation to the blasting work performed.

In accordance with a further advantageous embodiment, a slider can be provided for the setting of the blasting medium throughput in the blasting system, said slider being adjustable by an actuator provided with a distance measurement, with the slider being movable by a further actuator against a fixed abutment. With such a slider, on the one hand, a precise setting of the opening degree of the slider becomes possible and, on the other hand, the slider can be movable against a fixed abutment, which is in particular provided with an initiator, at the start of operation to create reproducible conditions.

In accordance with a further advantageous embodiment, the control can be provided with an interface for transmitting data to a public or private network. Thus, a bidirectional or unidirectional interface can be provided by which data of the control and generated pre-evaluations are made available to an edge device and/or on a web browser. In this way, access to generated evaluations is possible directly at the machine or via the Internet. A unidirectional interface offers the advantage of an increased safety of the machine with respect to the access to machine-relevant and safety-relevant functions from outside or via a data network. A display and a visualization of the evaluated or prepared data can take place in the form of absolute data, diagrams, images, and visualized representations on a wide variety of hardware devices, in particular if they enable a display with the aid of a browser.

The present invention will be described in the following purely by way of example with reference to different embodiments and to the enclosed drawings. There are shown:

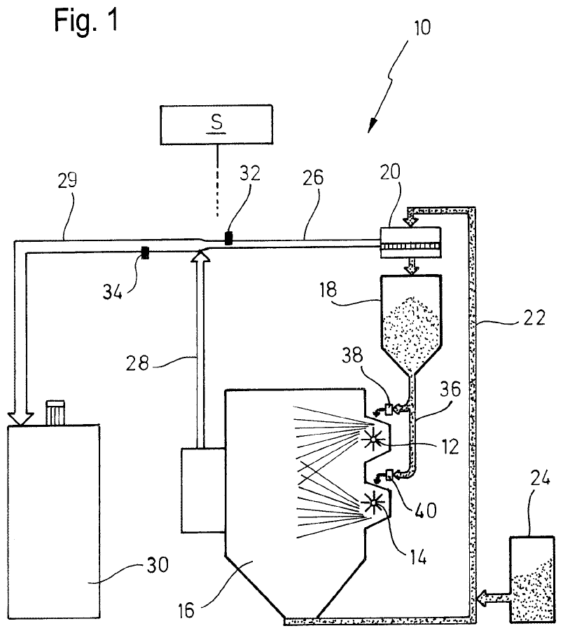

FIG. 1 a schematic representation of a blasting system;

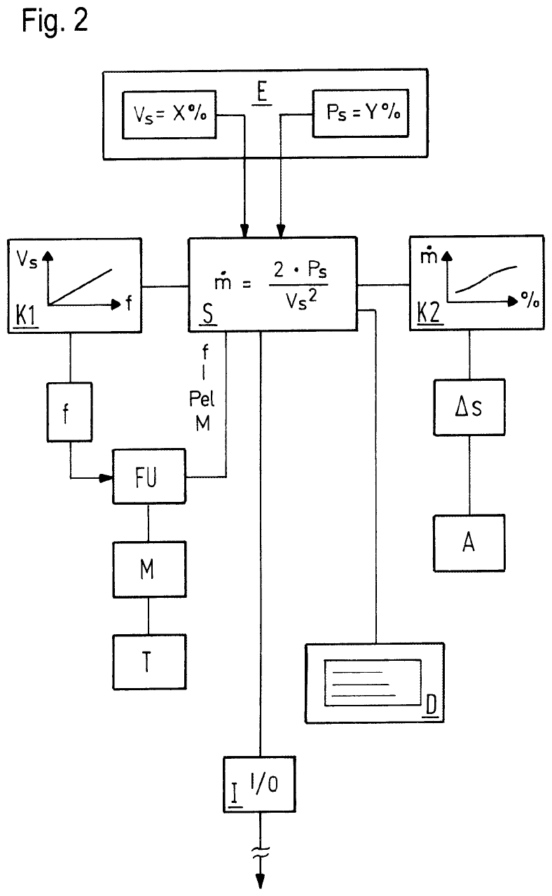

FIG. 2 a schematic representation of a method of operating a blasting system; and

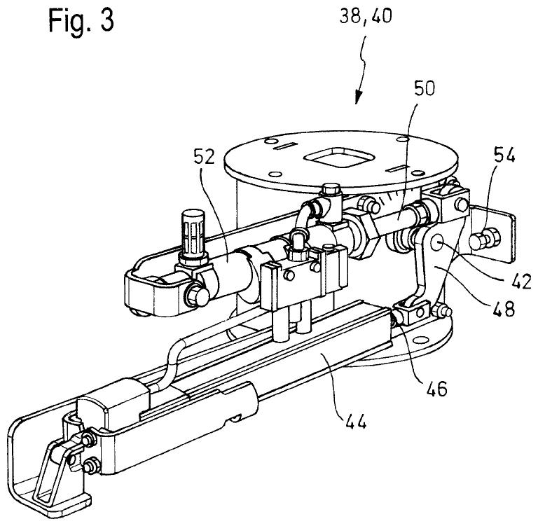

FIG. 3 a perspective view of an adjustment element.

FIG. 1 shows a schematic representation of a blasting system 10 that (in the embodiment shown) has two turbines 12 and 14 that are used for the blasting medium acceleration and that are each driven by an electric motor (not shown in FIG. 1). The turbines are arranged in a blasting chamber 16 through which parts or workpieces are guided and are blasted with a granular blasting medium. These types of blasting systems can be designed both as continuous flow systems or as batch systems for bulk goods or also for processing individual parts.

The feed of blasting medium to the turbines takes place via a storage container 18, with a cleaning unit 20 in the form of an air separator being connected upstream of said storage container 18. A return of blasting medium from the blasting chamber 16 takes place via a return unit 22, for example a bucket elevator, that conveys blasting medium from the blasting chamber 16 into the air separator 20. A subsequent metering of blasting medium can take place via a storage container 24 that functions as a gravimetric blasting medium metering such that the weight or the quantity of subsequently metered blasting medium can be determined at any time.

To clean the blasting medium, i.e. to free it from dust and undersize particles, air is sucked out both from the blasting chamber 16 via a line 28 and from the air separator 20 via a line 26 and guided into a suction system 30 in which the air is filtered and cleaned.

To separately detect both the air flow sucked out from the blasting chamber 16 and the air flow sucked out from the air separator 20, a first volume flow sensor 32 is provided in the line 26 and a further volume flow sensor 34 is provided in the line 29 leading to the suction system 30. Both the volume flow in the line 26 and the volume flow in the line 28 can be calculated or measured by these two volume flow sensors. Naturally, the volume sensor 34 or the volume sensor 32 could also be arranged in the line 28.

To regulate the quantity of blasting medium that is fed to each turbine 12 and 14, an adjustment element 38 and 40, which is configured as a slider, in particular as a slide valve, is arranged in the line 36 between the storage container 18 and the turbines 12 and 14 in front of each turbine.

FIG. 3 shows a perspective representation of an embodiment of a slide valve 38, 40 that has a slider flap (not shown) that is arranged in a housing and that is adjustable by a shaft 42. By rotating the shaft 42, the opening degree of the slider can be changed from 0 to 100%. To pivot the shaft 42, an actuator 44 provided with a distance measurement is provided that, in the embodiment shown, is configured as an electromechanical cylinder that can retract and extend its associated piston rod 46 with the aid of a spindle drive, for example. Via the built-in distance measurement, a precise determination of the respective position of the piston rod 46 and thus also of the opening degree can be detected. The piston rod 46 is connected to a pivot lever 48 that is in turn in connection with the shaft 42 so that the shaft 42 can be pivoted by extending the piston rod 46.

A further piston rod 50 of a further actuator 52, which is configured as a pneumatic cylinder in the embodiment shown, is likewise connected in an articulated manner to the shaft 42. Due to this pneumatic cylinder, the shaft 42 can be moved against a fixed abutment 54 by extending the piston rod 50 so that the piston rod 46 of the actuator 44 can be brought into a defined starting position by the actuator 52.

As FIG. 1 shows, a control S is provided for the control, monitoring, and evaluation of the total blasting system, said control S being connected to all the sensors, drives, motors, units, and other components of the blasting system. The blasting system can be operated, monitored, and evaluated with the aid of the control S as described in the following.

FIG. 2 illustrates the method steps set up in the control for operating the blasting system shown in FIG. 1. Thus, the control S comprises an input device E in which an operator can enter a desired ejection speed v_{S} and a desired blasting power P_{S} or the desired blasting medium throughput of the turbine. Both the ejection speed and the blasting power/the blasting medium throughput of the turbine can in this respect be entered as a percentage value X and Y or an absolute value (weight per unit of time and ejection speed). For example, a desired ejection speed v_{S} of 60% and a desired blasting power P_{S} of 100% can be predefined as a desired value.

In the control S, a required blasting medium throughput \dot{m}, which results from the formula \dot{m}=2 P_{S}/v_{S}², is then calculated as a weight per unit of time from these two desired values. With the blasting medium speed v_{S}, the frequency f which is required for the operation of the associated turbine and with which an electric motor M driving a turbine T must be controlled to achieve the desired ejection speed can be determined via a characteristic curve K1 stored in the control S. For this purpose, a frequency converter FU is connected upstream of the electric motor M and outputs electrical characteristic values such as frequency, current, voltage, electrical power, or torque to the control S. Due to the control of the frequency converter FU by the specification of a frequency F, the electric motor M can be operated at the desired rotational speed to drive the turbine T, i.e. one of the turbines 12 or 14.

To ensure that the desired blasting medium throughput \dot{m} is actually achieved, a further characteristic curve K2 is stored in the control S that is linked to the control S as a regulation basis. This characteristic curve K2 that is independent of the rotational speed reflects the dependence of the blasting medium throughput \dot{m} on the opening degree of the adjustment element 38, 40. In this respect, when the desired blasting medium throughput \dot{m} is known, the required opening path of the adjustment 38, 40 can be read off from the characteristic curve K2 so that a required variable Δs can be output by the control S in order to control an actuator A in the form of the respective adjustment element 38, 40 such that the desired opening path corresponds to a specific blasting medium throughput previously stored on an automated retraction of the characteristic curve.

FIG. 2 further illustrates that the control S is provided with a display D on which all the operating parameters and evaluations can be displayed. Furthermore, the control S is provided with an interface I by which the control can be connected to a private or public network, in particular in a browser-based manner.

A maximum output of the turbines is only achieved when a specific blasting medium quantity is ejected by the turbine. In general, the turbines can eject blasting media quantities in the order of magnitude between approximately 100 and 1000 kg/min. For a maximum blasting medium throughput, the motor (for example, an asynchronous motor) of the turbine is usually brought to its nominal rotational speed of, for example, 3000 rpm. In practice, the maximum mass flow of blasting medium that can be passed through by the respective turbine depending on the design is calculated by the software of the control and is limited via the actuator 44. The abutment 54 represents the reference abutment for the initialization of the start position.

Furthermore, the actuator 52 can also be used for an emergency stop function. If a power failure occurs in the blasting system, the air stored in the system is sufficient to move the pneumatic cylinder 52 into its closed position so that the slider is closed.

To determine the characteristic curve K2, a specific routine is provided in the control that gradually opens the respective slider of the adjustment elements 38, 40, for example with a stroke of 1 mm in each case, with the aid of the electromechanical cylinder 44. This position is then held for a specific time and the associated blasting medium throughput can be calculated and stored with the aid of the power and frequency output by the frequency converter. This procedure is then automatically or manually performed up to a predefined maximum blasting medium throughput so that the characteristic curve K2 results.

With the above-described control of the blasting system and the above-described procedures, a process and system monitoring can take place in real time under the aspects of parts quality, blasting work performed, media consumptions, system status, blasting power monitoring, wear, preventive maintenance, servicing, degree of utilization detection, and staff costs. In the control described, the following data are acquired, evaluated, and visualized in real time in accordance with the invention: Media consumptions (blasting media, compressed air, and electrical energy), blasting work performed, electrical power, productivity (degree of utilization), output of the machine, volume flows of the dust removal, volume flow of the blasting quantity in the air separation, volume flows of the blasting medium quantities at the blasting media acceleration systems, volume flow of the blasting medium in the air separation, blasting power, running times of the actuators.

The following parameters and calculations are used for the evaluation of the acquired data:

Turbine rotational speed n_{Turbine}

Nominal rotational speed of the corresponding blasting turbine during the parts processing in revolutions per minute.

Determination: Direct detection via the frequency inverter.

Current consumption I_{Turbine}

Current consumption of the corresponding turbine motor during the parts processing in amperes.

Determination: Direct detection via the frequency converter or, alternatively, via a separate inductive current transformer.

Electrical power Pₑₗ

Electrical power of the corresponding turbine motor during the part processing in kilowatts.

Determination: Direct detection via the frequency converter or, alternatively, via a calculation in the control using a current transformer.

Torque M_{Turbine}

Torque of the corresponding turbine motor during the parts processing in Newton meters.

Determination: Direct detection via the frequency inverter.

Ejection speed v_{S}

Speed of the blasting medium on leaving the ejection bucket in meters per second.

Determination: Linear straight line in dependence on the turbine rotational speed. Predefined by a turbine-dependent pre-parameterization.

Blasting media throughput \dot{m}

Quantity of blasting medium that the blasting turbine passes through in kilograms per minute during the processing.

Determination: (2*Pₑₗ*Turbine efficiency)/v_{S}²

Blasting power P_{S}

Kinetic power of the blasting turbine during the parts processing in kilowatts.

Determination: P=\dot{m}*v_{S}²*0.5

Blasting time T_{Turbine}

The blasting time is that time during which the blasting turbine runs under load and the slider releases the blasting media flow.

Blasting work W_{Turbine}

Work of the blasting turbine during the parts processing in kilowatt hours.

Determination: W_{Turbine=}P_{S}*T_{Turbine}

Blasting efficiency η_{Turbine}

Relation between the electrical power of the turbine motor and the blasting power during the parts processing in percent.

Determination: P_{S}/Pₑₗ*100

In accordance with the invention, the monitoring and evaluation functions unique in blasting technology are substantially divided and organized into three main groups, namely parts quality, operating parameters, and maintenance.

To detect and evaluate the parts quality, electrical, electromagnetic, inductive, capacitive, optical, mechanical or sound-based sensors, which detect the blasting medium flowing through, are attached to the blasting medium cleaning unit, preferably counting up in the blasting medium conveying direction and preferably over the complete width of the cross-section through which can be flowed through by blasting medium. The sensors can also be designed as a unit or as a sensor system. If all the sensors detect blasting medium, this means that the maximum possible blasting medium throughput of the system (100%) is currently achieved. Similarly, the occupancy of half of the sensors means that the system is currently operating at a 50% blasting medium throughput. In conjunction with the detected blasting power of the blasting medium acceleration systems (in accordance with the invention, compressed air blasting systems can also be used instead of turbines) and the blasting medium quantities known therefrom for the individual acceleration systems, the occupancy of the sensors to be expected is determined via software. An evaluation of the plausibility of the currently applied blasting medium quantity in relation to the detection of the occupancy width of the blasting medium preparation system (air separator) provides the possibility of generating conclusions with respect to the current state of the blasting system and the uniformity of the currently parameterized process. To minimize an impairment of the cleaning result of the blasting media preparation, in this case of the separation, the suction points in the system are arranged such that a short flow of air is prevented and a uniform flowing through of the blasting media curtain in the air separator is provided. The volume flow sucked off by the blasting medium cleaning is likewise detected, recorded, and evaluated.

Due to the material removal that takes place during the blasting process, abrasion in the form of dust arises that accumulates in the air of the blasting chamber during the blasting process. To ensure the cleanliness of the components after the blasting, the blasting chamber (also known as the blasting space) is flushed through with air and is sucked out via a suitable exhaust system. In this respect, it is important to keep the sucked-out air quantity the same at all times so that the cleaning result at the components and the cleanliness of the component surfaces always remain the same. Expediently, a measurement of the suction volume flow of the blasting chamber and of the blasting medium separator, or of one of the two, and the measurement of the total volume flow can take place at a blasting system in accordance with the invention so that the difference of the total volume flow minus the respective partial volume flow results in the other volume flow. The detection of the volume flows takes place by differential pressure measurement systems, pilot tubes, vane anemometers, or calorimetric measurement sensors. The monitoring, recording, and evaluation of the volume flows provides direct information about the produced parts quality with respect to the surface cleanliness (freedom of dust) of the components after the blasting process and the consistency of the blasting medium cleaning. To keep the volume flows constant at all times, the drive motor of the suction system is expediently equipped with a frequency converter via which the consistency of the volume flows is ensured by a rotational speed and power regulation.

As an example, a blasting system is described comprising four turbines that, due to their size and power, can each apply 250 kg/min, i.e. together 1000 kg/min. If, at the turbines, the blasting medium throughput is now reduced to 125 kg/min and per turbine, the total volume flow of the blasting medium is thus also reduced to 50%, which the sensor system recognizes in the blasting medium preparation. If this quantity matches the expected quantity, the system status is shown as in order. If, for example, all four turbines run at 250 kg/min each, which in this case corresponds to 100% of the blasting medium flow, and the sensor system detects, with a smaller occupancy, a deviating blasting medium flow in the blasting medium preparation, this is shown in the system status. Thus, a presentation takes place in real time and the data are likewise collected, prepared, and visualized in an advantageously scalable evaluation. Evidence of a uniform processing result, in conjunction with the blasting power monitoring or the throughput monitoring, is thereby possible.

A further advantageous arrangement is designed such that the maximum blasting medium throughput of a system is known and, via the occupied sensors, a baffle flap actuated by an actuator regulates the distribution width of the blasting medium in the blasting medium separator in dependence on the quantity passed through. Thus, a constantly uniform blasting medium distribution and thus a stable and best possible blasting medium cleaning can be achieved.

A monitoring or an equipping of the actuator or of the blasting medium baffle flap by a measurement system for the path or an opening angle is likewise advantageous. Thus, in conjunction with the known blasting medium throughputs to be expected, already preset opening angles or opening widths, from which only a fine regulation then has to take place, can be approached via a regulation. Such a system is able to keep the blasting medium cleaning and distribution uniformly stable and optimal at all times irrespectively of cycle or batch times.

The blasting power is calculated from the mass and the speed of the accelerated blasting medium. Thus, the currently output blasting power is calculated in a characteristic curve field of the software via the rotational speed of a turbine, the blasting medium throughput, the friction and its known efficiency, for example. Parameters detected in real time such as the current consumption and the turbine rotational speed are monitored and regulated. The corresponding blasting medium quantity is fed to the blasting medium acceleration system (turbine, compressed air blasting system) via the adjustment element.

It is in accordance with the current prior art to store underlying machining parameters such as rotational speed values and desired current specifications here. In the solution reproduced by the invention, the parameterization of the values in the processing recipe, however, takes place with direct absolute values, with the parameters blasting medium quantity (in kg/min), ejection speed (in m/s), and/or blasting power (in kilowatts) selectable on a scale from 0-100%.

In accordance with the invention, the following advantages arise: An always ideal utilization of the available and retrievable turbine power, also in the field constant range in which it does not correspond to the nominal power of the drive motor. Very short setting times of the adjustment elements of the blasting medium metering for the blasting medium acceleration systems. A prevention of volume-related throughput disturbances at the blasting media acceleration systems and a constant blasting medium grain distribution in the operating mixture.

The preselected and applied blasting power is detected per acceleration system and the performed blasting work is determined. The summarized blasting work performed of the total machine is therefore used as the basis for the evaluation of the most varied costs, of the machine output, and of the media consumptions. For example, the detailed blasting medium consumption and the processed parts quantity per kilowatt hour or megajoule of blasting work performed can be presented. The blasting medium consumption is preferably detected via a gravimetric, volume flow-based or weight-based metering system that replenishes the blasting medium quantity requested by the machine as required.

The recording, compression, and archiving of these data offers the possibility of an accurate retrospection and an explicit comparison of different time durations. Advance planning and, for example, capacity forecasts are thus likewise possible.

The currents consumed and the powers output of all, or of the main, electrical drives located at the machine are likewise detected and evaluated in real time. The total electrical power of the system is detected and recorded in real time via a central power measurement device. Parallel to this detection and evaluation, the operating states of the machine are monitored, detected, and evaluated.

An operating state model comprising the following parameters is used for a clear representation of the operating states and for a determination of the technical availability of the machine:

Switched off T_{Aus}

Time during which an edge device does not receive data from the controller (PLC) when the latter is switched off. This time should not automatically appear in the diagrams, but can be shown separately.

Blasting time T_{S}

Time during which the turbines run under load (slide valve open)

Secondary time T_{N}

Time during the processing in which no turbine load takes place, e.g. loading and unloading, table turning, etc.

Ready time T_{Br}

The portion of the potential operating time T_{Betr} in which the machine is not actively used.

Setup time T_{R}

Time for the setting up of the system and the replacement of operating media (blasting media). The time is correspondingly selected and deselected (started and stopped) via a separate page on an HMI. The operator has to acknowledge the procedure by pressing a button before the setting up of the system. The PLC also records the setup time until a repeat actuation of the button. Alternatively, the time is also stopped on the switchover to automatic mode.

Machine at an emergency stop→T_{A} until the operator presses setup→T_{R}

Maintenance time T_{W}

This includes all the tasks provided in accordance with a maintenance plan, e.g. planned maintenance scopes, machine cleaning, and test runs after maintenance. The time is correspondingly selected and deselected (started and stopped) via a separate page on the HMI. The PLC records the maintenance time until a repeat actuation of the button. Alternatively, the time is also stopped on the switchover to automatic mode.

Technical downtime T_{A}

The sum of all the downtimes that are caused by deficiencies in the design or execution of the machine. They are e.g. the repair of a malfunction, etc. The downtime is the duration of time from the occurrence of a malfunction up to its elimination, i.e. the time until the system has been brought into an operational state again.

Summarized times and ratios

Degree of utilization T_{Ng}

Describes the ratio of the ready time T_{Br} and the operating time T_{Betr} in the following formula:

T_{Ng}=((T_{Betr}−T_{Br})/T_{Betr})=T_{Nu}/T_{Betr}

Utilization time T_{Nu}

During the utilization time, the machine produces at its full scope of performance. In other words, the sum of the blasting time T_{S} and the secondary time T_{N}. The utilization time is the time when the automatic mode is started and no malfunction is present (machine is running).

Operating time T_{Betr}

Operating time is the time during which the system could potentially produce.

Availability T_{V}

The system availability indicates the ratio between the technical downtime T_{A} and the occupancy time T_{B} in “%”.

Determination of the availability V_{T}=100%−((T_{A}/T_{B})*100%)

Occupancy time T_{B}

Since different and also changing shift models are often present at the client, a specification of the occupancy time is not always advantageous. Therefore, the occupancy time TB can be set to start with the main switch “On” and can be set to stop with the main switch “Off”. It is therefore the sum of times at which the main switch of the machine was switched on.

The edge device can be wired and installed, including required peripherals (e.g. a 24 V DC power supply and fuse), before the main switch. The required timestamps are generated at the edge side.

A further component of the invention is the monitoring and replacement recommendation of the most important wear parts by detailed wear state detection systems, a stored individual part-related wear part history, and further service life forecasts. In accordance with the invention, maintenance and inspections are thus precisely schedulable and an operator-oriented spare parts logistics can be implemented without wasteful storage.

The further advantages resulting from the invention are: a precise detection of the blasting work performed; a detailed consumption detection and consumption monitoring of media such as blasting media, electrical energy, and compressed air with respect to the blasting work performed; a monitoring and replacement recommendation of the most important wear parts by detailed wear state detection systems, an individual part-related wear part history and further service life forecasts; a detection and a possible evaluation of the machine output and of the processing costs of individual components or component batches; a precise degree of utilization detection of the machine and/or of the machine occupancy (occupancy factor); capacity forecasts and advance planning; best possible quality control.

1. A method of operating a blasting system that has a control and at least one turbine which is driven by an electric motor and by which granular blasting medium is accelerated and is ejected onto workpieces in a blasting chamber,
wherein
a desired ejection speed and a desired blasting power of the turbine are entered in the control,
a required blasting medium throughput is calculated from the predefined ejection speed and the blasting power, and
a quantity of blasting medium that is fed to the turbine is set on the basis of the calculated blasting medium throughput.

2. The method in accordance with claim 1,
wherein the ejection speed and the blasting power are entered in the control as a percentage value or as an absolute value.

3. The method in accordance with claim 1,
wherein a characteristic curve that reproduces the dependence of the ejection speed of the turbine on a rotational speed of the electric motor is stored in the control.

4. The method in accordance with claim 1,
wherein the setting of the quantity of blasting medium takes place by an adjustment element controlled by the control.

5. The method in accordance with claim 4,
wherein a characteristic curve that reproduces the dependence of the blasting medium throughput on an opening degree of the adjustment element is stored in the control.

6. The method in accordance with claim 5,
wherein the characteristic curve is generated in that the adjustment element is brought into different positions, and wherein, for each position, the current blasting medium throughput is calculated and stored from the current blasting power and the current ejection speed.

7. The method in accordance with claim 4,
wherein the adjustment element is moved into a predefined end position at the start of operation.

8. The method in accordance with claim 4,
wherein the adjustment element is moved into a predefined end position at the start of operation, with an end position that is taught on a putting into operation of the adjustment element being initialized.

9. The method in accordance with claim 5,
wherein a plurality of characteristic curves are stored at time intervals in the control, and wherein a malfunction message or wear message is output by the control in the event of a significant change of the characteristic curves.

10. The method in accordance with claim 1,
wherein the electric motor is controlled by a frequency converter, and wherein the rotational speed, a current consumption, an electrical power, and/or a torque of the electric motor is/are transmitted from said frequency converter to the control.

11. The method in accordance with claim 1,
wherein the actual blasting power of the turbine is calculated from the electrical power of the electric motor and a previously determined turbine efficiency.

12. The method in accordance with claim 1,
wherein a limit value for a maximum permissible blasting medium throughput is entered in the control.

13. The method in accordance with claim 1,
wherein a storage container for blasting medium is provided, and wherein a spatial distribution of the blasting medium to be introduced into the storage container is detected.

14. The method in accordance with claim 13,
wherein a process monitoring takes place in the control by establishing a correlation between the detected spatial distribution of the blasting medium to be introduced into the storage container and the calculated blasting medium throughput.

15. The method in accordance with claim 1,
wherein air is sucked out both from the blasting chamber and from the region of a blasting medium cleaning unit, and wherein a volume flow of both suctions is detected and monitored.

16. The method in accordance with claim 1,
wherein the blasting power of the turbine and a product of the blasting power and a blasting time are determined and are displayed by the control as blasting work.

17. The method in accordance with claim 1,
wherein the actually performed blasting work of blasting medium acceleration devices is detected and stored.

18. The method in accordance with claim 17,
wherein a blasting medium consumption and/or a processed parts quantity, which are likewise detected, are put into relationship with the blasting work performed and being displayed by the control.

19. A blasting system that has a control and at least one turbine which is driven by an electric motor and by which blasting medium is accelerated and ejected in a blasting chamber,
wherein the control is configured and adapted to calculate a required blasting medium throughput from a predefined ejection speed and a predefined blasting power, and to predefine a quantity of blasting medium that is fed to the turbine on the basis of the calculated blasting medium throughput.

20. The blasting system in accordance with claim 19,
wherein the control determines the performed blasting work of the blasting system in real time and displays and/or stores operating parameters of the blasting system in relation to the blasting work performed.

21. The blasting system in accordance with claim 19,
wherein a slider is provided for the setting of the blasting medium throughput, said slider being adjustable by an actuator provided with a distance measurement, with the slider being movable against a fixed abutment by a further actuator.

22. The blasting system in accordance with claim 21,
wherein the actuator is an electromechanical cylinder.

23. The blasting system in accordance with claim 21,
wherein the further actuator is a pneumatic cylinder.

24. The blasting system in accordance with claim 19,
wherein the control is provided with an interface for transmitting data to a public or private network.
